(19) United States
(12) Patent Application Publication
(10) Pub. No.: US 2020/0375231 A1
(43) Pub. Date: Dec. 3, 2020

(54) PURE PEANUT BUTTER PREPARED BY USING COMPOUNDED PEANUT VARIETIES AND PREPARATION METHOD THEREOF

(71) Applicant: Institute of Food Science and Technology, Chinese Academy of Agricultural Sciences, Beijing (CN)

(72) Inventors: Qiang WANG, Beijing (CN); Hui HU, Beijing (CN); Hongzhi LIU, Beijing (CN); Hongwei YU, Beijing (CN); Aimin SHI, Beijing (CN); Li LIU, Beijing (CN); Qin GUO, Beijing (CN)

(21) Appl. No.: 16/593,891

(22) Filed: Oct. 4, 2019

(30) Foreign Application Priority Data
May 31, 2019 (CN) 2019104710303

(51) Int. Cl. A23L 25/10

(52) U.S. Cl. CPC A23L 25/10; A23V 2002/00

(57) ABSTRACT

A pure peanut butter is prepared by compounded peanut varieties. The raw material of the pure peanut butter includes: 50 to 90 parts of high oleic peanuts and 10 to 50 parts of high sugar peanuts. The preparation method is as follows: high oleic peanuts and high sugar peanuts are respectively baked, the baking conditions for the high oleic peanuts are as follows: a baking temperature of 140 to 180° C., and a baking time of 15 to 35 minutes; the baking conditions for the high sugar peanuts are as follows: a baking temperature of 130 to 160° C., and a baking time of 10 to 30 minutes; and the baked high oleic peanuts and high sugar peanuts are subjected to ventilation and cooling, and after removal of peanut skin, mixed and then subjected to coarse grinding and fine grinding.

### INCORPORATION BY REFERENCE TO ANY PRIORITY APPLICATIONS

Any and all applications for which a foreign or domestic priority claim is identified in the Application Data Sheet as filed with the present application are hereby incorporated by reference.

### BACKGROUND OF THE INVENTION

### Field of the Invention

The present invention relates to the field of food processing, in particular to a pure peanut butter prepared by using compounded peanut varieties and a preparation method thereof.

### Description of the Related Art

China is the world's largest producer and consumer of peanuts. In 2018, the total yield of peanuts is about 17 million tons, accounting for 40% of the world's yield of peanuts. With the constant increasing demand for nutritional health products, the variety of peanut foods will continue to increase, with a processed food proportion up to 41%, which is about 10% higher than that of a decade ago. Peanut butter is not only rich in vegetable proteins, but also rich in vitamins (nicotinic acid, vitamin E and the like) and minerals, and rich in nutrients, and peanut butter has unique flavor, and is one of the main consumption forms of peanut foods.

Peanut butter products include pure peanut butter, stabilized peanut butter and granular peanut butter. Peanut butter without any other additives is pure peanut butter, peanut butters supplemented with ingredients such as stabilizers or containing peanut granules are stabilized/granular peanut butters. Most of the pure peanut butter consumed in China is used as a sauce for hot pot, and a small portion is used for protein beverage processing. In foreign countries, especially in the United States, peanut butter has become a part of the daily diet, and the mainly consumed peanut butter is stabilized/granular peanut butter, which is widely used in foods such as bread, sandwiches, candy and the like.

Peanut butter has a high fat content. Pure peanut butter without stabilizers will have an oil-separation phenomenon during storage, is easily to be oxidized and rancid, and is easy to produce tallowy smell especially in summer, which seriously affects the flavor quality and shelf life of the product. Moreover, the non-fat portion naturally settles to form a hard solid substance during storage, thereby causing the decreased fluidity and the deteriorated texture of the pure peanut butter, and thus the pure peanut butter is difficult to eat.

### SUMMARY OF THE INVENTION

In order to improve the flavor, texture and shelf life of the pure peanut butter, the present invention provides a pure peanut butter prepared by using compounded peanut varieties and a preparation method thereof. Wherein, high oleic peanuts and high sugar peanuts are used as the raw material for preparation, and different special baking processes are adopted, which solves the problems that the pure peanut butter is easy to be oxidized and rancid, and easy to produce a tallowy smell, the fluidity of the pure peanut butter is degraded and the texture thereof is deteriorated during storage.

Unless otherwise specified, the high oleic peanuts and high sugar peanuts used in the present invention are commercially available.

In a first aspect, the present invention provides a pure peanut butter prepared by using compounded peanut varieties, the raw material includes: 50 to 90 parts of high oleic peanuts and 10 to 50 parts of high sugar peanuts, wherein, the content of the oleic acid of the high oleic peanuts is 75% or more, and the fat content of the high oleic peanuts is 40% or more; and the content of the sucrose of the high sugar peanuts is 6% or more.

Preferably, the raw material includes 60 to 80 parts of high oleic peanuts and 20 to 40 parts of high sugar peanuts.

More preferably, the raw material includes 70 parts of high oleic peanuts and 30 parts of high sugar peanuts.

Pure peanut butter is a kind of peanut butter without any additives, is often used as a hot pot sauce and used in protein beverage processing, and can be prepared by directly baking and grinding peanuts. The pure peanut butter provided by the present invention, which is prepared from the compounded raw material of high oleic peanuts and high sugar peanuts, not only has the characteristics of high oleic peanuts which are not easy to be oxidized and rancid, but also has a unique sweet taste which is not possessed by the pure peanut butter prepared from a general peanut variety due to the introduction of the high sugar peanut variety. In particular, the pure peanut butter prepared by using the high oleic peanuts and the high sugar peanuts in the weight ratio provided by the present invention has a moderate sweetness, and as compared with the pure peanut butter prepared by using the high oleic peanuts or the high sugar peanuts alone, the texture of the pure peanut butter provided by the present invention is significantly improved, the fluidity is better, and the viscosity is moderate.

In a second aspect, the present invention provides a method for preparing a pure peanut butter using a raw material of compounded peanut varieties, comprising:

high oleic peanuts and high sugar peanuts are respectively placed in an oven and baked under different conditions;

the baked high oleic peanuts and high sugar peanuts are subjected to ventilating and cooling for 5 minutes, and after the removal of peanut skin (the removal rate of the peanut skin is 95% or more), mixed and stirred to give a mixture;

the mixture was subjected to coarse grinding and fine grinding to give the pure peanut butter.

Preferably, the baking conditions for the high oleic peanuts are as follows: a baking temperature of 140 to 180° C., and a baking time of 15 to 35 minutes;

The baking conditions for the high sugar peanuts are as follows: a baking temperature of 130 to 160° C., and a baking time of 10 to 30 minutes.

More preferably, the baking conditions for the high oleic peanuts are as follows: a baking temperature of 155 to 165° C., and a baking time of 20 to 30 minutes;

The baking conditions for the high sugar peanuts are as follows: a baking temperature of 140 to 150° C., and a baking time of 15 to 25 minutes.

More preferably, the baking conditions for the high oleic peanuts are as follows: a baking temperature of 160° C., and a baking time of 25 minutes;

The baking conditions for the high sugar peanuts are as follows: a baking temperature of 145° C., and a baking time of 20 minutes.

The present invention adopts different baking conditions for the high oleic peanuts and the high sugar peanuts. Since high oleic peanuts and high sugar peanuts have different ratios of nutritional ingredients, it is needed to select different baking temperatures and times, so that the prepared pure peanut butter has a better roasted flavor, is less prone to burnt, and has a sweeter taste and no bitterness.

Preferably, after the mixture is subjected to coarse grinding and fine grinding, the fineness of the pure peanut butter is 100 mesh or more.

More preferably, the pure peanut butter has a fineness of 170 to 200 mesh.

In a preferred embodiment of the present invention, the method for preparing a pure peanut butter by using raw material of compounded varieties comprises the following steps:

High oleic peanuts and high sugar peanuts with uniform size and without mildew or deterioration phenomenon are selected as raw material, 60 to 80 parts of high oleic peanuts and 20 to 40 parts of high sugar peanuts are respectively placed in an oven for baking, and the baking conditions are as follows:

the baking conditions for the high oleic peanuts are as follows: a baking temperature of 155 to 165° C., and a baking time of 20 to 30 minutes;

the baking conditions for the high sugar peanuts are as follows: a baking temperature of 140 to 150° C., and a baking time of 15 to 25 minutes;

the baked high oleic peanuts and high sugar peanuts are subjected to ventilation and cooling for 5 minutes, and after the removal of peanut skin (the removal rate of the peanut skin is 95% or more), mixed and stirred to give a mixture;

the mixture is subjected to coarse grinding and fine grinding.

The pure peanut butter prepared by using raw material of compounded varieties and a preparation method thereof provided by the present invention have the following beneficial effects:

(1) The present invention simultaneously uses high oleic peanuts and high sugar peanuts as raw material for preparing pure peanut butter for the first time, and defines a specific ratio. The prepared peanut butter has moderate sweetness, good fluidity, moderate viscosity, and good stability. After storage at room temperature for one year, the peanut butter remains a uniform color, strong roasted flavor and no peculiar smell, and only a thin layer of oil is obtained.

(2) The present invention establishes different special baking conditions for high oleic peanuts and high sugar peanuts according to the characteristics of these two varieties, so that the prepared pure peanut butter has a better roasted flavor, is less prone to burnt, and has a sweeter taste and no bitterness.

### DETAILED DESCRIPTION OF THE PREFERRED EMBODIMENT

In order to make the purposes, technical solutions, and advantages of the Examples of the present invention more clear, the technical solutions in the Examples of the present invention will be clearly and completely described. It is apparent that the described Examples are a part of the embodiments of the present invention, rather than all of the embodiments. All other embodiments obtained by a person skilled in the art based on the Examples of the present invention without creative efforts are within the scope of the present invention.

### Example 1

The present Example provides a pure peanut butter prepared by using raw material of compounded varieties, and the preparation method thereof comprises the following specific steps:

High oleic peanuts (with a content of the oleic acid of 75% or more, and a fat content of 40% or more) and high sugar peanuts (with a content of the sucrose of 6% or more) with uniform size and without mildew or deterioration phenomenon were selected as raw material, 70 parts of high oleic peanuts and 30 parts of high sugar peanuts were respectively placed in an oven for baking, and the baking conditions were as follows:

the baking conditions for the high oleic peanuts were as follows: a baking temperature of 160° C., and a baking time of 25 minutes;

the baking conditions for the high sugar peanuts were as follows: a baking temperature of 145° C., and a baking time of 20 minutes;

the baked high oleic peanuts and high sugar peanuts were subjected to ventilation and cooling for 5 minutes, and after the removal of peanut skin (the removal rate of the peanut skin is 95% or more), mixed and stirred to give a mixture;

the mixture was subjected to coarse grinding and fine grinding to give a pure peanut butter having a fineness of 170 to 200 mesh, which was rapidly cooled to room temperature and then filled.

### Example 2

The present Example provides a pure peanut butter, and the preparation method was the same as that in Example 1, except that the composition of the raw material was as follows:

50 parts of high oleic peanuts and 50 parts of high sugar peanuts.

### Example 3

The present Example provides a pure peanut butter, and the preparation method was the same as that in Example 1, except that the composition of the raw material was as follows:

90 parts of high oleic peanuts and 10 parts of high sugar peanuts.

### Example 4

The present Example provides a pure peanut butter, and the preparation method was the same as that in Example 1, except that the baking temperature for the high oleic peanut was 170° C.

### Example 5

The present Example provides a pure peanut butter, and the preparation method was the same as that in Example 1, except that the baking temperature for the high sugar peanut was 160° C.

### Example 6

The present Example provides a pure peanut butter, and the preparation method was the same as that in Example 1, except that the peanut butter has a fineness of 100 mesh.

### Comparative Example 1

The present Comparative Example provides a pure peanut butter, and the preparation method was the same as that in Example 1, except that only a common peanut variety (with a content of the oleic acid of 30 to 55%) was used as the raw material, and the baking conditions for the high oleic peanut in Example 1 were used as the baking conditions.

### Comparative Example 2

The present Comparative Example provides a pure peanut butter, and the preparation method was the same as that in Example 1, except that only the high oleic peanut (with a content of the oleic acid of 75% or more, and a fat content of 40% or more) was used as the raw material, and the baking conditions for the high oleic peanut in Example 1 were used as the baking conditions.

### Comparative Example 3

The present Comparative Example provides a pure peanut butter, and the preparation method was the same as that in Example 1, except that only the high sugar peanut (with a content of the sucrose of 6% or more) was used as the raw material, and the baking conditions for the high sugar peanut in Example 1 were used as the baking conditions.

### Experimental Example 1

In the present Experimental Example, the pure peanut butters obtained in Examples 1-6 and Comparative Examples 1-3 were compared in terms of color, scent, texture and mouthfeel after being placed at room temperature for one week and one year, and the results were as follows:

TABLE 1
Comparison results of pure peanut butters stored at room temperature for one week

| | Placed at room temperature for one week | | | |
|---|---|---|---|---|
| | Color | Scent | Texture | Taste |
| Example 1 | Golden | Strong roasted aroma | Good fluidity | Moderate sweetness, no |
| | yellow | and sweet aroma | Thick paste | bitterness or other |
| | | | | peculiar smell, delicate |
| | | | | taste, no granular |
| | | | | sensation |
| Example 2 | Golden | Strong roasted aroma | Relatively poor fluidity | Somewhat too sweet, |
| | yellow | and sweet aroma | The paste is too thick | no bitterness or other |
| | | | | peculiar smell, delicate |
| | | | | taste, no granular |
| | | | | sensation |
| Example 3 | Golden | Strong roasted aroma | Relatively good fluidity | Slightly sweet, no |
| | yellow | and a little sweet | Relatively thick paste | bitterness or other |
| | | aroma | | peculiar smell, delicate |
| | | | | taste, no granular |
| | | | | sensation |
| Example 4 | Brownish | Strong roasted aroma | Good fluidity | Obvious bitterness |
| | yellow | and burnt odor | Thick paste | |
| Example 5 | Brownish | Strong roasted aroma | Good fluidity | Obvious bitterness |
| | yellow | and burnt odor | Thick paste | |
| Example 6 | Golden | Strong roasted aroma | Good fluidity | Moderate sweetness, no |
| | yellow | and sweet aroma | Thick paste | bitterness or other |
| | | | | peculiar smell, rough |
| | | | | taste, and granular |
| | | | | sensation |
| Comparative | Golden | Relatively strong | Relatively good fluidity | No bitterness or other |
| Example 1 | yellow | roasted aroma | Relatively thick paste | peculiar smell, delicate |
| | | | | taste, no granular |
| | | | | sensation |
| Comparative | Golden | Strong roasted aroma | Relatively good fluidity | No bitterness or other |
| Example 2 | yellow | | Slightly thin paste | peculiar smell, delicate |
| | | | | taste, no granular |
| | | | | sensation |
| Comparative | Golden | Strong sweet aroma | Very poor fluidity | Too sweet, no bitterness |
| Example 3 | yellow | | Very thick butter | or other peculiar smell |

TABLE 2
Changes of the pure peanut butter stored at room temperature for one year

| | Placed at room temperature for one year | | | |
|---|---|---|---|---|
| | Color | Scent | Texture | Taste |
| Example 1 | No change | No change | A thin layer of oil is separated | No change |
| | | | Good fluidity | |
| Example 2 | No change | Strong roasted aroma | A small amount of oil is | Slightly bitter |
| | | and sweet aroma | separated | taste |
| | | A little tallowy smell | | |
| Example 3 | No change | No change | A thin layer of oil is separated | No change |
| | | | Good fluidity | |
| Example 4 | No change | No change | A thin layer of oil is separated | Obvious |
| | | | | bitterness |
| Example 5 | No change | No change | A thin layer of oil is separated | Obvious |
| | | | | bitterness |
| Example 6 | No change | No change | A small amount of oil is | No change |
| | | | separated | |
| | | | Lower paste is hard | |
| | | | Poor fluidity | |
| Comparative | No change | Strong tallowy smell | A large amount of oil is | Obvious |
| Example 1 | | | separated | bitterness |
| Comparative | No change | No change | A thin layer of oil is separated | No change |
| Example 2 | | | | |
| Comparative | No change | Strong tallowy smell | A large amount of oil is | Obvious |
| Example 3 | | | separated | bitterness |

Specifically, pure peanut butter is a kind of peanut butter without adding any additives. Under this premise, the pure peanut butter provided by the present invention uses high oleic peanuts and high sugar peanuts as raw material, and special baking conditions for the high oleic peanuts and the high sugar peanuts are simultaneously established. The prepared pure peanut butter has the following beneficial effects:

(1) Compared with the pure peanut butter prepared by using only a common peanut variety, the pure peanut butter of the present invention has better stability, maintains a sweet taste after stored at room temperature for one year, and does not produce a tallowy flavor, and only a thin layer of oil is separated, and the pure peanut butter has better fluidity, and moderate viscosity.

(2) Compared with the pure peanut butter prepared by using the high oleic peanuts alone, the pure peanut butter of the present invention has sweet and moderate taste, thick paste, and better texture.

(3) Compared with the pure peanut butter prepared by using the high sugar peanuts alone, the pure peanut butter of the present invention has better fluidity.

(4) High oleic peanuts and high sugar peanuts are respectively baked under different special baking conditions, so that the pure peanut butter of the present invention has better flavor, is less prone to burnt, and has a sweet taste and no bitterness.

It should be noted that the above Examples are only used to illustrate the technical solutions of the present invention, and are not limited thereto. Although the present invention has been described in detail with reference to the foregoing Examples, a person skilled in the art should understand that: the technical solutions described in the foregoing Examples may be modified, or some of the technical features may be equivalently replaced. The modifications and substitutions of the present invention do not depart from the spirit and scope of the technical solutions of the Examples of the present invention.

1. A pure peanut butter prepared by a raw material of compounded varieties, wherein the pure peanut butter is prepared from the raw material in parts by weight comprises the following ingredients:
50 to 90 parts of high oleic peanuts and 10 to 50 parts of high sugar peanuts.

2. The pure peanut butter prepared by using the compounded peanut varieties according to claim 1, wherein the pure peanut butter is prepared from the raw material in parts by weight comprises the following ingredients:
60 to 80 parts of high oleic peanuts and 20 to 40 parts of high sugar peanuts.

3. The pure peanut butter prepared by using the compounded peanut varieties according to claim 2, wherein the pure peanut butter is prepared from the raw material in parts by weight comprises the following ingredients:
70 parts of high oleic peanuts and 30 parts of high sugar peanuts.

4. The pure peanut butter prepared by using the compounded peanut varieties according to claim 1, wherein a content of an oleic acid of the high oleic peanuts is 75% or more, and a fat content of the high oleic peanuts is 40% or more; and a content of sucrose of the high sugar peanuts is 6% or more.

5. A method for preparing the pure peanut butter by using the raw material of the compounded varieties according to claim 1, comprising:
baking the high oleic peanuts and the high sugar peanuts respectively;
subjecting the baked high oleic peanuts and high sugar peanuts to ventilation and cooling; and
after removing a peanut skin, mixing and then subjecting to coarse grinding and fine grinding to give the pure peanut butter.

6. The method for preparing the pure peanut butter by using the compounded peanut varieties according to claim 5, wherein the baking conditions for the high oleic peanuts are as follows: a baking temperature of 140 to 180° C., and a baking time of 15 to 35 minutes; and/or
the baking conditions for the high sugar peanuts are as follows: a baking temperature of 130 to 160° C., and a baking time of 10 to 30 minutes.

7. The method for preparing the pure peanut butter by using the compounded peanut varieties according to claim 6, wherein the baking conditions for the high oleic peanuts are as follows: a baking temperature of 155 to 165° C., and a baking time of 20 to 30 minutes; and/or
the baking conditions for the high sugar peanuts are as follows: a baking temperature of 140 to 150° C., and a baking time of 15 to 25 minutes.

8. The method for preparing the pure peanut butter by using the compounded peanut varieties according to claim 7, wherein the baking conditions for the high oleic peanuts are as follows: a baking temperature of 160° C., and a baking time of 25 minutes; and/or
the baking conditions for the high sugar peanuts are as follows: a baking temperature of 145° C., and a baking time of 20 minutes.

9. The method for preparing the pure peanut butter by using the compounded peanut varieties according to claim 5, wherein a fineness of the pure peanut butter is 100 mesh or more after the coarse grinding and fine grinding.

10. The method for preparing the pure peanut butter by using the compounded peanut varieties according to claim 9, wherein the fineness of the pure peanut butter is 170 to 200 mesh after the coarse grinding and fine grinding.

11. The pure peanut butter prepared by using compounded peanut varieties according to claim 2, wherein the content of the oleic acid of the high oleic peanuts is 75% or more, and the fat content of the high oleic peanuts is 40% or more; and the content of the sucrose of the high sugar peanuts is 6% or more.

12. The pure peanut butter prepared by using compounded peanut varieties according to claim 3, wherein the content of the oleic acid of the high oleic peanuts is 75% or more, and the fat content of the high oleic peanuts is 40% or more; and the content of the sucrose of the high sugar peanuts is 6% or more.
